(19) United States
(12) Patent Application Publication
(10) Pub. No.: US 2019/0329181 A1
(43) Pub. Date: Oct. 31, 2019

(54) AFTERTREATMENT CATALYSIS AT DECREASED EFFECTIVE LIGHT-OFF TEMPERATURES

(71) Applicant: BATTELLE MEMORIAL INSTITUTE, Richland, WA (US)

(72) Inventors: Kenneth G. Rappe, Kennewick, WA (US); Xiaohong Shari Li, Richland, WA (US)

(73) Assignee: BATTELLE MEMORIAL INSTITUTE, Richland, WA (US)

(21) Appl. No.: 15/962,353

(22) Filed: Apr. 25, 2018

(51) Int. Cl. B01D 53/94; B01J 20/04; B01J 35/00; F01N 3/08; F01N 3/28

(52) U.S. Cl. CPC B01D 53/9481; B01J 20/041; B01J 20/043; B01J 35/0006; F01N 2370/02; F01N 3/0814; F01N 3/28; F01N 2570/10; F01N 2510/0684; F01N 3/0857

(57) ABSTRACT

Described herein are catalyst systems and methods of treating emissions that can passively heat aftertreatment catalysts. Also described herein are methods of making such catalyst systems. Aftertreatment catalyst systems can include a catalyst support structure having a surface region on which a criteria-pollutant-treating catalyst and a sorbent exist. Non-limiting examples of sorbents can include those based on MgO, MgO—NaCO₃ double salts, or dolomite. The sorbent can include a eutectic promotor that facilitates exothermic CO₂ adsorption from the exhaust to the sorbent at a first temperature below the light-off temperature of the catalyst. Heat from formation of an exotherm between CO₂ and components of the sorbent is passively transferred to the criteria-pollutant-treating catalyst to increase the surface-region (i.e., catalyst bed) temperature to a value greater than or equal to the light-off temperature, thereby lowering the apparent light-off temperature.

### ACKNOWLEDGEMENT OF GOVERNMENT SUPPORT

This invention was made with Government support under Contract DE-AC0576RL01830 awarded by the U.S. Department of Energy. The Government has certain rights in the invention.

### FIELD

The present disclosure relates to catalytic treatment of engine emissions and more particularly to systems and methods for catalytic treatment of engine emissions at low-temperatures such as those occurring during a cold-start period.

### BACKGROUND

Criteria air pollutants (CAP) are typically released from a variety of sources including industry mining, transportation, electricity generation, and agriculture. In many cases, CAPs are products of the combustion of fossil fuels or industrial processes. They are air pollutants that can cause smog, acid rain, and other health hazards. Examples can include CO, SOₓ, hydrocarbons (HC), and NOₓ.

While catalytic treatment in the transportation industry has improved greatly, current engine exhaust aftertreatment catalysts still provide very low activity at temperatures less than or equal to 150° C.; the activity levels fall well short of the 90% efficient emissions conversion targeted by government and industry. Even with potential catalyst advancements, there will still be issues surrounding emissions reduction at low temperatures such as those during vehicle cold start. These emissions are estimated to contribute up to 60%-80% of the total automotive HC emissions. As aftertreatment systems continue to improve and emissions regulations tighten, the emissions released at low temperatures and during cold-start will constitute an increasingly large fraction of the overall vehicle emissions that will require reduction for achieving reduced emissions. Accordingly, there is a need for catalysis methods and systems that minimize emissions at low-temperatures by more rapidly heating the catalyst and shortening the cold-start period.

### SUMMARY

Disclosed herein are catalyst systems having decreased effective light-off temperatures, methods of catalytically treating pollutants at low temperature, and method of making the catalyst systems.

In some embodiments, a method of catalytically treating pollutants at low temperature comprises exposing engine exhaust to an aftertreatment catalyst system comprising a catalyst support structure having a surface region comprising a criteria-pollutant-treating catalyst and a sorbent comprising a eutectic promotor. The sorbent is based on MgO, on a MgO—Na₂CO₃ double salt, or on dolomite. The method can further comprise exothermically adsorbing CO₂ from the exhaust to the sorbent at a first temperature less than a light-off temperature of the criteria-pollutant-treating catalyst, thereby increasing temperature at the criteria-pollutant-treating catalyst to a value greater than or equal to the light-off temperature; and desorbing the CO₂ from the sorbent at a second temperature greater than the light-off temperature of the criteria-pollutant-treating catalyst.

In certain embodiments, the first temperature is less than 150° C. In certain embodiments, the second temperature is greater than 250° C. In certain embodiments, the sorbent is at a first layer on a surface of the support structure and the catalyst is at a second layer on the first layer, and wherein said adsorbing comprises adsorbing CO₂ to the first layer and said increasing temperature comprises transferring heat from the first layer to the second layer. In certain embodiments, the eutectic promotor has a melting temperature that is less than or equal to 150° C., and wherein the method further comprises melting the eutectic promotor, thereby facilitating said adsorbing CO₂. In certain embodiments, the eutectic promotor comprises a mixture of at least two salts selected from the group consisting of NaNO₃, LiNO₃, KNO₃, Ca(NO₃)₂ Mg(NO₃)₂, NaNO₂, LiNO₂, KNO₂, and CaNO₂. In certain embodiments, the eutectic promotor comprises a ternary mixture of NaNO₃, KNO₃, and NaNO₂, a ternary mixture of LiNO₃, NaNO₃, and KNO₃, or a quarternary mixture of LiNO₃, NaNO₃, KNO₃, and NaNO₂. In certain embodiments, the eutectic promotor is 5 wt % to 60 wt % of the sorbent's total weight. In certain embodiments, the sorbent and the criteria-pollutant-treating catalyst are present in a weight ratio between 1:2 and 4:1. In certain embodiments, the weight ratio is between 1:1 and 3:1.

In some embodiments, an aftertreatment catalyst for engine exhaust comprises a catalyst support structure having a surface region comprising a criteria-pollutant-treating catalyst and a MgO-based, a MgO—Na₂CO₃ double salt-based, or a dolomite-based sorbent comprising a eutectic promotor. The aftertreatment catalyst has a CO₂-capture temperature less than or equal to 150° C. and a CO₂-release temperature greater than or equal to 250° C., wherein the sorbent is a CO₂ exotherm. The CO₂-capture and CO₂-release temperatures can be determined by the composition of the sorbent and eutectic promotor as described herein.

In certain embodiments, the sorbent is arranged as a first layer and the catalyst is arranged as a second layer, the first layer existing between the support structure and the second layer. In certain embodiments, at least a portion of the sorbent can be located inside the porosity of the support structure. In certain embodiments, the sorbent can be located inside the porosity of the support structure and in a layer at the surface region of the support structure. In certain embodiments, the sorbent and the catalyst are integrated in a layer on the support structure. In certain embodiments, the eutectic promotor comprises a mixture of salts selected from the group consisting of NaNO₃, LiNO₃, KNO₃, Ca(NO₃)₂, Mg(NO₃)₂, NaNO₂, LiNO₂, KNO₂, and Ca(NO₂)₂. In certain embodiments, the eutectic promotor comprises a ternary mixture of NaNO₃, KNO₃, and NaNO₂, a ternary mixture of LiNO₃, NaNO₃, and KNO₃, or a quarternary mixture of LiNO₃, NaNO₃, KNO₃, and NaNO₂. In certain embodiments, the eutectic promotor is 5 wt % to 60 wt % of the sorbent's total weight. In certain embodiments, the sorbent and the criteria-pollutant-treating catalyst are present in a weight ratio between 1:2 and 4:1. In certain embodiments, the eutectic promotor has a melting temperature that is less than or equal to 150° C.

In some embodiments, a method of synthesizing a catalyst system comprises applying to a surface of a catalyst support structure a criteria-pollutant-treating catalyst and a MgO-based, a MgO—Na₂CO₃ double salt-based, or a dolomite-based sorbent comprising a eutectic promotor. The sorbent comprising the eutectic promotor has a CO₂-capture temperature less than or equal to 150° C. and a CO₂-release temperature greater than or equal to 250° C., wherein the sorbent is a CO₂ exotherm.

In certain embodiments, said applying comprises first applying the sorbent or the catalyst as a first layer on the catalyst support structure and subsequently applying the catalyst or the sorbent, respectively, as a second layer on the first layer. In certain embodiments, said applying comprises applying an integrated layer comprising the sorbent and the catalyst.

The purpose of the foregoing summary and the latter abstract is to enable the United States Patent and Trademark Office and the public generally, especially the scientists, engineers, and practitioners in the art who are not familiar with patent or legal terms or phraseology, to determine quickly from a cursory inspection the nature and essence of the technical disclosure of the application. Neither the summary nor the abstract is intended to define the invention of the application, which is measured by the claims, nor is it intended to be limiting as to the scope of the claims in any way.

### BRIEF DESCRIPTION OF THE DRAWINGS

FIGS. 1A-1C are illustrations depicting various embodiments of catalyst systems having a catalyst support structure with a surface region comprising a CAP-treatment catalyst and a sorbent comprising a eutectic promotor and based on MgO, on a MgO—Na₂CO₃ double salt, and/or on dolomite.

FIG. 2 is a graph of weight change as a function of temperature for three different sorbents demonstrating the lower melting point eutectic promotor lowering the temperature at which the sorbent begins to capture CO₂.

FIGS. 3A-3D contain phase diagrams (FIGS. 3A and 3B) of eutectic promotors and graphs (FIGS. 3C and 3D) of CO₂ adsorption, catalyst inlet temperature, and differential scanning calorimetry data (μV) for MgO-based sorbents having different eutectic promotor compositions.

FIGS. 4a-4C are graphs showing the effect of weight percent of eutectic promotor in the sorbent. The graphs show CO₂ adsorption, catalyst inlet temperature, and differential scanning calorimetry data (μV) for various MgO based (or MgO—Na₂CO₃ double salt-based) sorbents having different amounts of eutectic promotor.

FIGS. 5A-5B are temperature versus time graphs showing the effects of CO₂ adsorption on catalyst bed temperature.

FIG. 6 is a graph of the inlet temperature, the bed temperature, and the CO₂ concentration for a catalyst system according to embodiments described herein.

FIG. 7 is a graph that compares the selective catalytic reduction of NO using a Fe/ZSM-5 SCR without a sorbent and with a sorbent.

FIGS. 8A-8C are graphs showing oxidation of NO to NO₂ with and without a CO₂ sorbent to demonstrate the impact of the catalyst systems described herein.

### DETAILED DESCRIPTION

Many aftertreatment catalysts function inadequately at low temperature, such as those that exist during an engine's cold start period, and fall short of the emission conversion targets identified by government and industry. Pollutant storage and release materials have been pursued to bridge the gap between engine start-up and catalyst light-off, including HC traps and passive NOₓ adsorbers (PNAs). However, significant challenges remain with these materials, including insufficient trapping capacity and poor matching of release behavior to conversion. Described herein are catalyst systems and methods of treating emissions that can passively provide heat to the criteria-pollutant-treating catalyst. Also described herein are methods of making such catalyst systems.

The inventors have determined that reducing cold-start emissions have traditionally been approached in two ways: 1) capturing on solid sorbents (e.g., traps and/or adsorbers) exhaust pollutants that can't be catalytically converted during the cold-start period so they can be later released and treated at higher temperature; or 2) using active thermal management techniques to shorten the effective cold-start period. Strategies could include both of these, and often do. Subsequent to combustion, active thermal management can include adding and/or recuperating heat and typically incur a fuel penalty as energy is required for operation. In contrast, a strategy that passively heats the after-treatment catalyst would be of significant interest because it does not require energy input for operation. Such systems can reduce emissions associated with cold start by shortening the effective cold start period without incurring a fuel penalty.

The problem of poor catalyst activity during a cold-start period can be solved by an aftertreatment catalyst system that has a decreased effective light-off temperature and that comprises a catalyst support structure having a surface region comprising a criteria-pollutant-treating catalyst and a sorbent comprising a eutectic promotor. The sorbent can be based on MgO, on a MgO—Na₂CO₃ double salt, and/or on dolomite. CO₂ from the exhaust adsorbs exothermically to the sorbent at a first temperature below the light-off temperature of the catalyst. Heat from formation of an exotherm between CO₂ and a component of the sorbent is passively transferred to the criteria-pollutant-treating catalyst to increase the surface-region (i.e., catalyst bed) temperature to a value greater than or equal to the light-off temperature. Absent the eutectic, the capacity of the MgO-based, the MgO—Na₂CO₃ double salt-based, and/or on dolomite-based sorbent alone is very low, almost negligible. The eutectic enables the sorbent to function at low temperature, which in one embodiment, can be attributed to the decrease of diffusive and kinetic resistance. The eutectic's softening or melting point essentially acts as a ‘trigger’ facilitating CO₂ capture with the active component (e.g., MgO). Below the eutectic softening or melting point, there is no significant CO₂ capture. Thus, when a vehicle is off there is no continued CO₂ capture by the sorbent.

A result of having the sorbent present with the catalyst during operation is an apparent decrease in the light-off temperature through passive heating from an exotherm that is intimate thermal contact with the criteria-pollutant-treating catalyst. Temperature increase can be localized near the surface region of the support structure, where the catalyst bed is located. In certain embodiments, the heat from the exotherm is not used to heat the entire support structure (e.g., monolith) nor is it used to heat an insulator of the catalyst system. Rather, it is used to rapidly heat the criteria-pollutant-treating catalyst to a temperature greater than or equal to the light-off temperature, thereby lowering the effective light-off temperature.

The CO₂ can be desorbed from the sorbent when the surface region and/or the catalyst system achieves a second temperature that is greater than or equal to the light-off temperature, thereby preparing the catalyst system for a subsequent cold-start period. In one example, the sorbent can release captured CO₂ at temperatures greater than the catalyst's light-off temperature in the vehicle drive cycle where there is little or no impact on catalyst performance, thereby functioning in reversible fashion for repetitive vehicle cold-start. Accordingly, the catalyst system can function reversibly and no net CO₂ capture is required.

By using exhaust heat to regenerate the CO₂ sorbent, which is then available for re-use to again capture CO₂ at a lower temperature and produce heat to shorten the cold-start period, embodiments described herein utilize exhaust energy recovery to address cold-start emissions. This is an unexpected result because desorption of the CO₂ is endothermic and has the potential to extinguish catalyst activity by lowering the temperature to a value below the light-off temperature. In embodiments described herein, the temperature of the catalyst bed and/or the support structure is sufficiently high that the endothermic desorption does not extinguish catalyst activity. Another perspective is that the thermal mass is sufficiently high that the endothermic desorption does not extinguish catalyst activity.

The sorbent can be integrated with the criteria-pollutant-treating catalyst or it can be a layer proximal to a layer comprising the catalyst. The sorbent can be applied as a layered washcoat using existing catalyst support structures and current after-treatment catalyst manufacturing processes. The sorbent can comprise a bulk metal oxide promoted by a molten salt that can act as a phase transfer catalyst to significantly facilitate the CO₂ sorption reaction in a highly exothermic fashion. In some embodiments, the sorbent comprises a MgO-based, an MgO—Na₂CO₃ double salt-based, or a dolomite-based sorbent comprising a eutectic promotor. In certain embodiments, the eutectic promotor comprises a ternary or quaternary mixture of Na, K, and Li nitrate and/or nitrite salts and has a softening/melting point between 80° C. and 160° C. In certain embodiments, the eutectic promotor comprises 5 wt % to 45 wt % of the total sorbent. The capability of a molten eutectic component (i.e., promotor) to dissolve bulk MgO can facilitate a dynamic MgO dissolution and precipitation equilibrium providing activated MgO that is accessible to CO₂ reaction that otherwise is not. Although the eutectic promotor can exist as a molten phase during CO₂ capture, the bulk material can still be handled as a solid sorbent. Examples can include, but are not limited to, the ternary NaNO₃/KNO₃/NaNO₂ system, the ternary LiNO₃/NaNO₃/KNO₃ system, and the quaternary LiNO₃/NaNO₃/KNO₃/NaNO₂ system.

The following explanations of terms and abbreviations are provided to better describe the present disclosure and to guide those of ordinary skill in the art in the practice of the present disclosure. As used herein, “comprising” means “including” and the singular forms “a” or “an” or “the” include plural references unless the context clearly dictates otherwise. The term “or” refers to a single element of stated alternative elements or a combination of two or more elements, unless the context clearly indicates otherwise.

Unless explained otherwise, all technical and scientific terms used herein have the same meaning as commonly understood to one of ordinary skill in the art to which this disclosure belongs. Although methods and materials similar or equivalent to those described herein can be used in the practice or testing of the present disclosure, suitable methods and materials are described below. The materials, methods, and examples are illustrative only and not intended to be limiting. Other features of the disclosure are apparent from the following detailed description and the claims.

Unless otherwise indicated, all numbers expressing quantities of components, molecular weights, percentages, temperatures, times, and so forth, as used in the specification or claims are to be understood as being modified by the term “about.” Accordingly, unless otherwise implicitly or explicitly indicated, or unless the context is properly understood by a person of ordinary skill in the art to have a more definitive construction, the numerical parameters set forth are approximations that may depend on the desired properties sought and/or limits of detection under standard test conditions/methods as known to those of ordinary skill in the art. When directly and explicitly distinguishing embodiments from discussed prior art, the embodiment numbers are not approximations unless the word “about” or “approximately” is recited.

### EXAMPLES AND COMPARISONS

To further illustrate certain embodiments of the disclosed catalyst systems, catalysis methods, and methods of making the catalyst systems, and to provide various comparative analyses and data, below are some Examples with comparison test data.

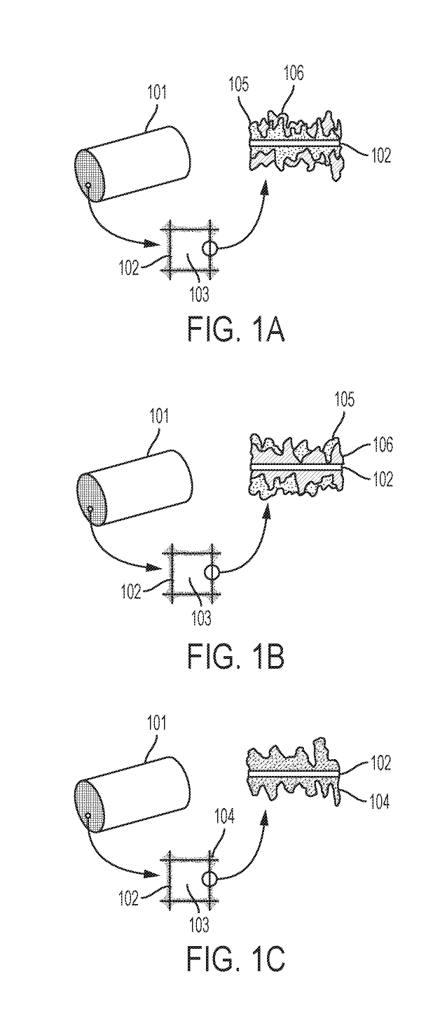

Referring to FIGS. 1A-1C, illustrations depict various embodiments of catalyst systems comprising a catalyst support structure 101 having a large surface area over which exhaust can flow. As illustrated, the support structure comprises a plurality of channels 103 defined by walls 102. The surface region on the walls can comprise a criteria-pollutant-treating catalyst and a MgO-based, a MgO—Na₂CO₃ double salt-based, or a dolomite-based sorbent comprising a eutectic promotor. In the illustration of FIG. 1A, the criteria-pollutant-treating catalyst 105 is a first layer on the surfaces of the support structure channel walls 102. The sorbent with eutectic promotor 106 is a second layer on the first layer. In the illustration of FIG. 1B, the sorbent with eutectic promotor 106 is a first layer on the surfaces of the support structure channel walls 102. The criteria-pollutant-treating catalyst 105 is a second layer on the first layer. In FIG. 1C, an integrated layer 104 is applied to the support structure channel walls 102. The integrated layer comprises a mixture of the criteria-pollutant-treating catalyst and the sorbent with eutectic promotor. With regard to embodiments in which the catalyst and the sorbent are primarily applied in separate layers, a region of intermixing can occur at the interface of the two layers.

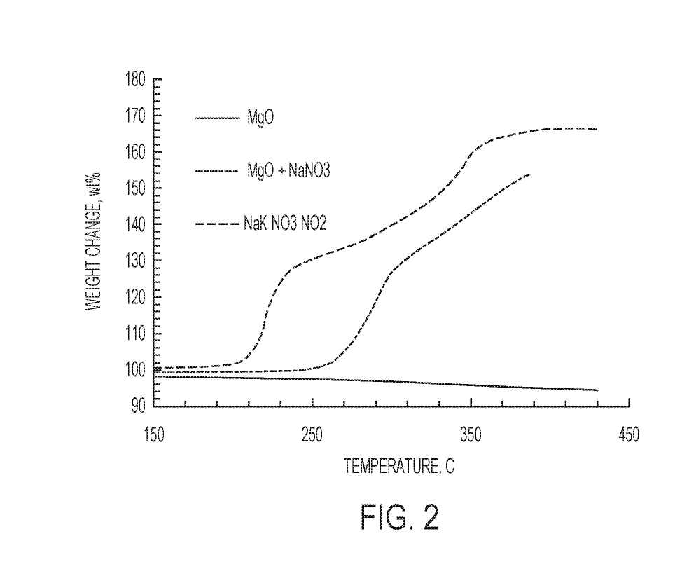

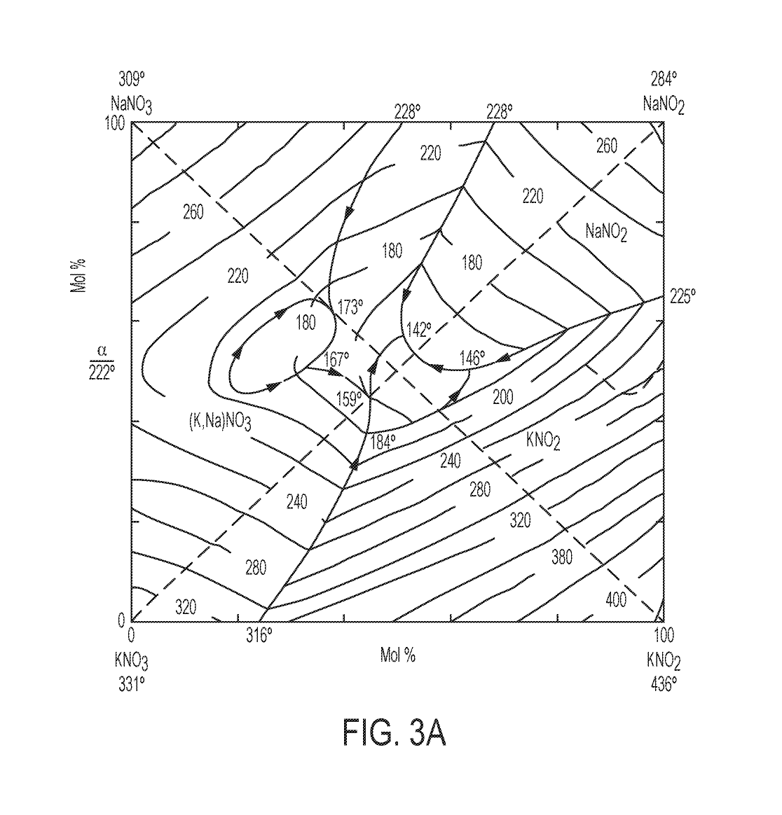

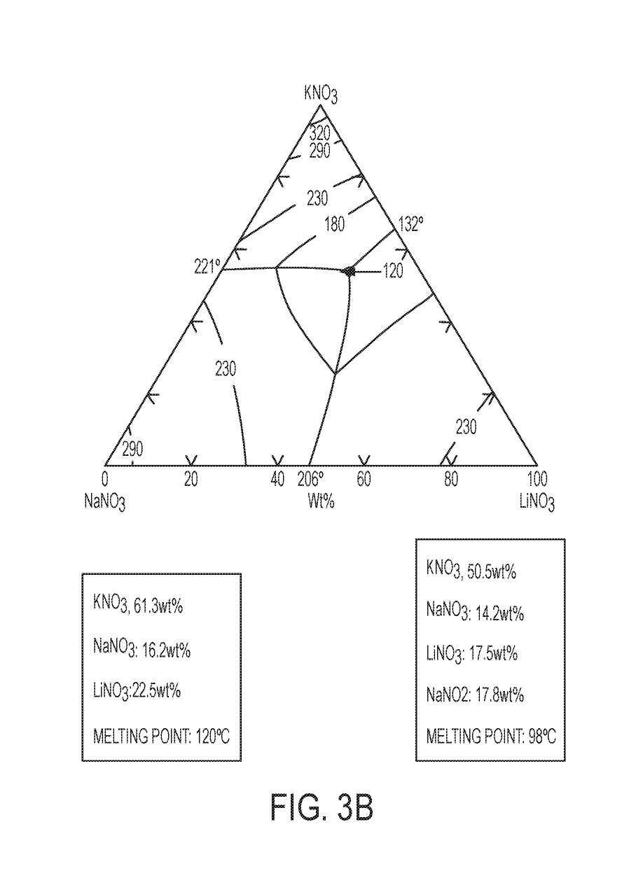

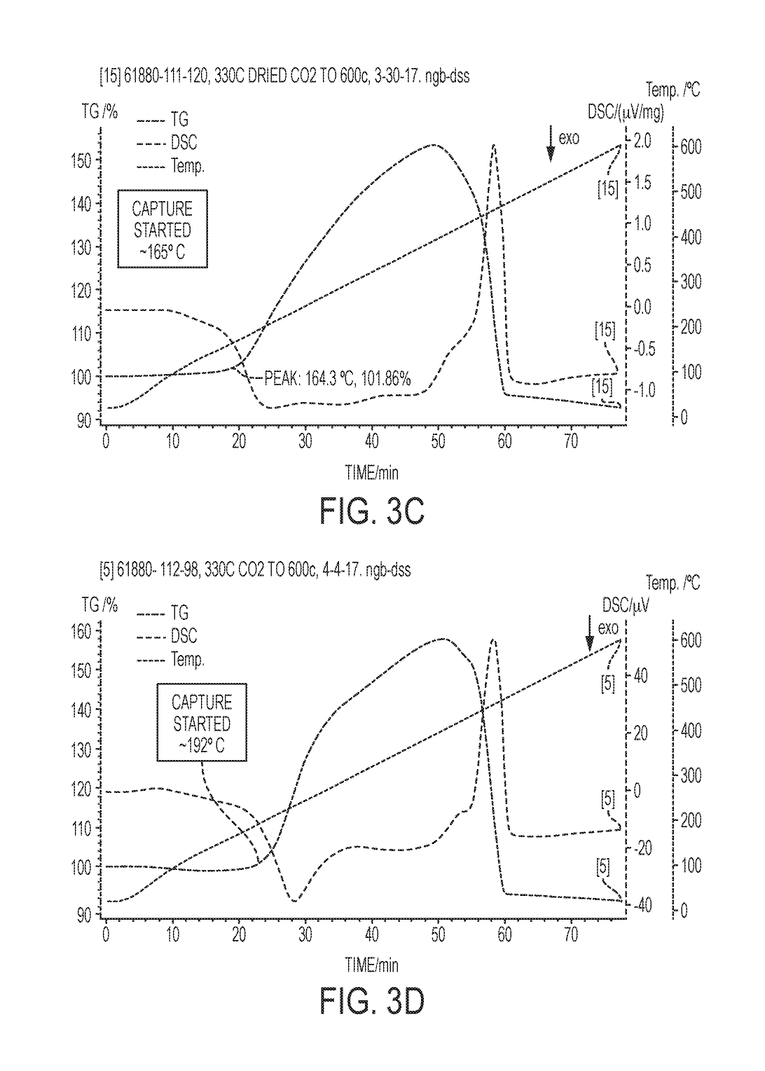

Referring to FIG. 2, a graph of weight change as a function of temperature for three different sorbents demonstrates a lower melting point eutectic lowering the temperature at which the sorbent begins to capture CO₂. An MgO sorbent without a eutectic promotor shows no weight gain in the temperature range of 150° C. to 430° C. An MgO-based sorbent comprising a NaNO₃ eutectic begins adsorbing CO₂ at a temperature between approximately 250° C. and 270° C., which is at the pre-melting point of NaNO₃. An MgO-based sorbent comprising a NaKNO₃—NaNO₂ eutectic (melting point 142° C.) begins adsorbing CO₂ at an approximate temperature of 200° C. The NaKNO₃—NaNO₂ eutectic (melting point 142° C.) comprises 52.8 wt % KNO₃, 7.1 wt % NaNO₃, and 40.1 wt % NaNO₂. The phase diagram is shown in FIG. 3A. The NaNO₃-promoted MgO sorbent had 15 wt % NaNO₃ and the NaKNO₃—NaNO₂ eutectic promoted sorbent contained 80 wt % MgO, 10.6 wt % KNO₃, 1.4 wt % NaNO₃, and 8.0 wt % NaNO₂.

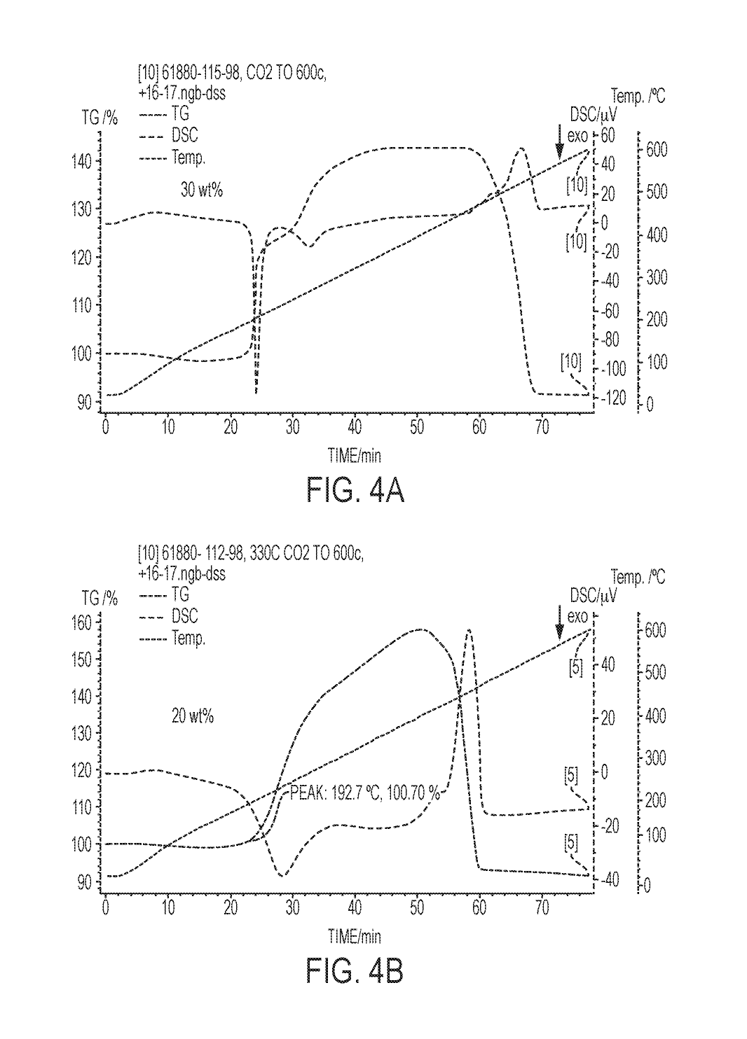

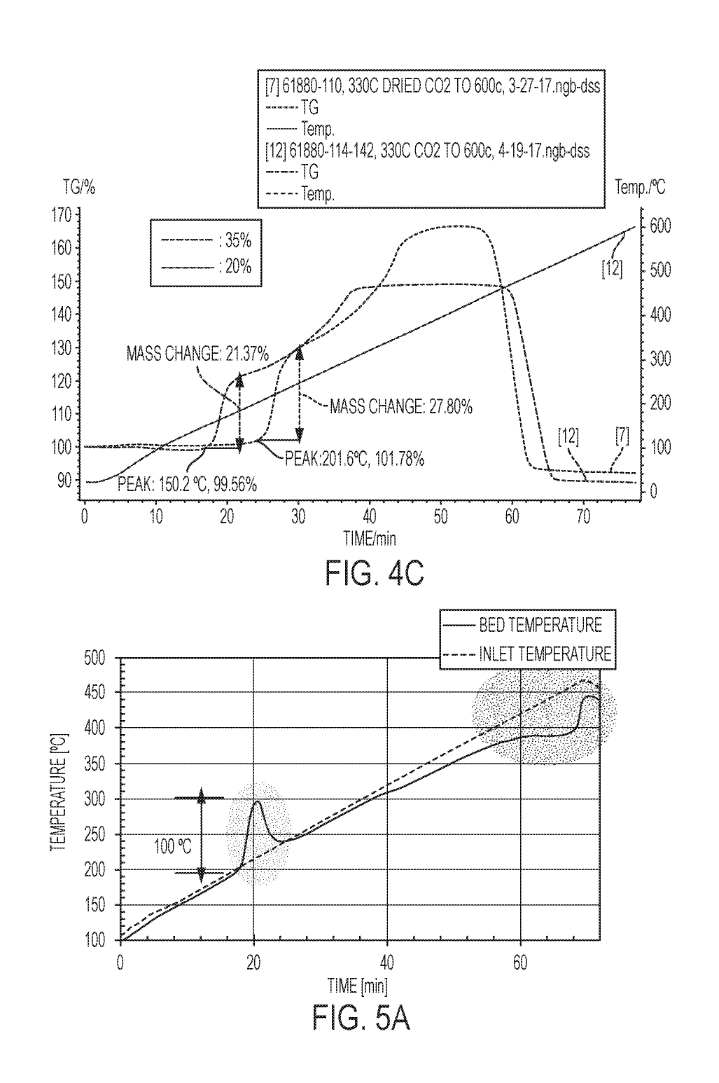

MgO can be obtained by calcining Mg₅(CO₃)₄(OH)₂.xH₂O powder at 450-490° C. for about 3 hours in air. The obtained MgO was mixed with metal nitrate salts at desired weight ratios using a ball milling method. The solid mixtures were added into a plastic bottle and mixed with 2-propanol and zirconia beads (diameter: 0.3-1 cm). The bottle was rotated for 48-72 hours at a speed of 60 rpm. The obtained slurry was dried at 25° C. to allow the evaporation of 2-propanol. Following drying, the cake was calcined at 330-400° C. in air in an alumina crucible, for 2-4 hours. Additionally, details of samples for FIGS. 3A-3D and 4A-4C are summarized in Tables 1A and 1B.

TABLE 1A
A summary of sample compositions by weight
for data shown in FIGS. 3 and 4.

| Sample | Samples | Weight, g | | | | | |
|---|---|---|---|---|---|---|---|
| ID | in FIG. | MgO | KNO₃ | NaNO₃ | LiNO₃ | NaNO₂ | Na₂CO₃ |
| 60880- | 3B | 1.6 | 0.245 | 0.065 | 0.089 | 0 | |
| 111-120 | | | | | | | |
| 61880- | 3C | 1.6 | 0.202 | 0.057 | 0.07 | 0.071 | |
| 112-98 | | | | | | | |
| 61880- | 4A | 1.1 | 0.303 | 0.089 | 0.105 | 0.107 | 0.3 |
| 115-98 | | | | | | | |
| 61880- | 4B | 1.6 | 0.202 | 0.057 | 0.07 | 0.071 | |
| 112-98 | | | | | | | |
| 61880- | 4C, | 1.6 | 0.212 | 0.028 | | 0.16 | |
| 110 | Purple | | | | | | |
| 61880- | 4C, | 1.3 | 0.37 | 0.049 | | 0.28 | |
| 114 | Blue | | | | | | |

TABLE 1B
A summary of sample compositions by weight
percentage for data shown in FIGS. 3 and 4.

| Sample | Samples | Weight, % | | | | | |
|---|---|---|---|---|---|---|---|
| ID | in FIG. | MgO | KNO₃ | NaNO₃ | LiNO₃ | NaNO₂ | Na₂CO₃ |
| 60880- | 3B | 80% | 12.3% | 3.3% | 4.5% | 0.0% | |
| 111-120 | | | | | | | |
| 61880- | 3C | 80% | 10.1% | 2.9% | 3.5% | 3.6% | |
| 112-98 | | | | | | | |
| 61880- | 4A | 55% | 15.1% | 4.4% | 5.2% | 5.3% | 15% |
| 115-98 | | | | | | | |
| 61880- | 4B | 80% | 10.1% | 2.9% | 3.5% | 3.6% | |
| 112-98 | | | | | | | |
| 61880- | 4C, | 80% | 10.6% | 1.4% | 0.0% | 8.0% | |
| 110 | Purple | | | | | | |
| 61880- | 4C, | 65% | 18.5% | 2.5% | 0.0% | 14.0% | |
| 114 | Blue | | | | | | |

The CO₂ absorption and desorption tests were conducted with a thermogravimetric analyzer at ambient pressure. The weight of the absorbent sample for each test was approximately 20 mg. CO₂ absorption was evaluated by heating sample in 100% CO₂ to 600° C. with 7.5 C/min heating rate. The gas flow rate was maintained at 70 ml/min for CO₂. The absorption heat was measured along with the TG tests through differential scanning calorimetry (DSC).

CO₂ capture can occur at an even lower initial temperature in MgO-based, MgO—Na₂CO₃ double salt-based, or dolomite-based sorbents comprising other eutectic promoters. The temperature at which exothermic CO₂ adsorption begins is related to the effective light-off temperature of catalyst systems described herein. Referring to FIG. 3A, a phase diagram is shown for a quaternary eutectic promotor having a melting point of 142° C. The quaternary promotor comprises 52.83% KNO₃, 7.1 wt % NaNO₃, and 40.1 wt % NaNO₂. Referring to FIG. 3B a phase diagram is shown for a ternary eutectic promotor having a melting point of 120° C. The ternary promotor comprises 61.3% KNO₃, 16.2 wt % NaNO₃, and 22.5 wt % LiNO₃. A quaternary eutectic promotor can comprise 50.5 wt % KNO₃, 14.2 wt % NaNO₃, 17.5 wt % LiNO₃, and 17.8 wt % NaNO₂, which has a melting point of 98° C. The graph in FIG. 3B shows that CO₂ capture for the ternary eutectic promotor began at about 165° C. in a 10% CO₂/air mixture. The graph in FIG. 3C shows the quaternary eutectic promotor began adsorbing CO₂ at a temperature of about 192° C.

The graphs in FIGS. 4A-4C indicate that weight percent of eutectic promotor in the sorbent can be altered to tune the rate of CO₂ adsorption and the temperature at which adsorption initiates. Accordingly, the amount of heat generated and the onset of heat generation can be tuned in the catalyst system. Comparing FIGS. 4A and 4B, the sorbent having a greater amount of the eutectic promotor (FIG. 4A of a sorbent having 30 wt % eutectic promotor) exhibited a higher rate of CO₂ adsorption and the adsorption began at a lower temperature. FIG. 4C shows similar results in which a sorbent having 35 wt % eutectic promotor began adsorbing CO₂ at about 150° C. compared to 202° C. for the sorbent having 20 wt % eutectic promotor.

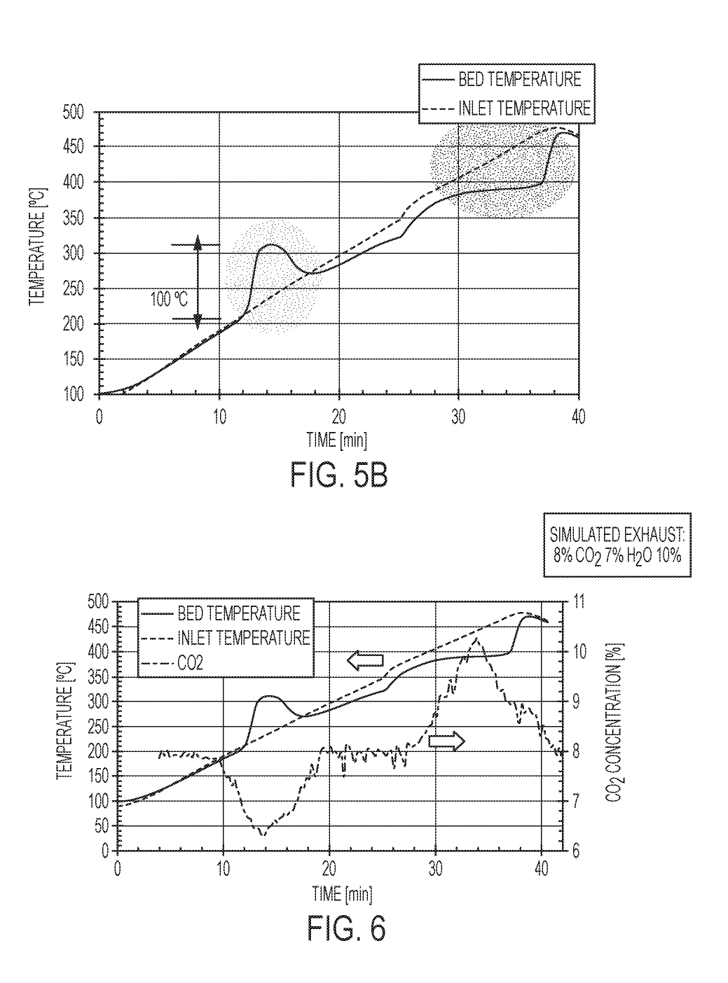

In FIGS. 5A-5B, the effects of CO₂ adsorption of shown in the temperature versus time graphs. In particular, the bed temperature is compared to the inlet temperature at two different heating rates in a sample support structure having sorbents with quaternary eutectic promotors applied to a surface region. The structure is exposed to simulated exhaust comprising 8% CO₂, 7% H₂O, 10% O₂, and balance N₂. Significantly, beginning at about 200° C., an exotherm is observed associated with CO₂ adsorption. The exotherm increases the bed temperature to at least 300° C. Desorption of the CO₂ occurs at a subsequent time when the inlet and bed temperatures are above 375° C. The endothermic desorption of CO₂ lowers the bed temperature but not to a temperature that would extinguish the catalytic activity of a criteria-pollutant-treating catalyst.

The sorbents with eutectic promotors shown in FIGS. 5-8 were synthesized as follows. 10 g of 52.83% KNO₃, 7.1 wt. % NaNO₃, and 40.1 wt. % NaNO₂ were dissolved in 20 g of water, dried at 60 C and granted. 3.5 g of the granted nitrate salts were mixed with 6.5 g of MgO obtained by calcining Mg₅(CO₃)₄(OH)₂.xH₂O powder at 450-490° C. for 3 hours in air. The solid mixtures were added into a plastic bottle and mixed with 40 g of 2-propanol and 167 g of zirconia beads (diameter: 1 cm). The bottle was rotated for 60 hours at a speed of 60 rpm. The obtained slurry was dried at 25° C. to allow the evaporation of 2-propanol. Following drying, the cake was calcined at 330° C. in air for 2 hours and then sieved to 60-100 mesh.

Referring to FIG. 6, the inlet temperature, the bed temperature, and the CO₂ concentration is shown for a structure and sorbent similar to that used to generate the data in FIG. 5. The exotherm and endotherm are appropriately associated with CO₂ adsorption and desorption. Furthermore, about 30 wt % CO₂ was adsorbed at the lower temperature and after desorption, approximately 100% of the adsorbed CO₂ was recovered. Accordingly, no net CO₂ capture occurred, and the sorbent is regenerable.

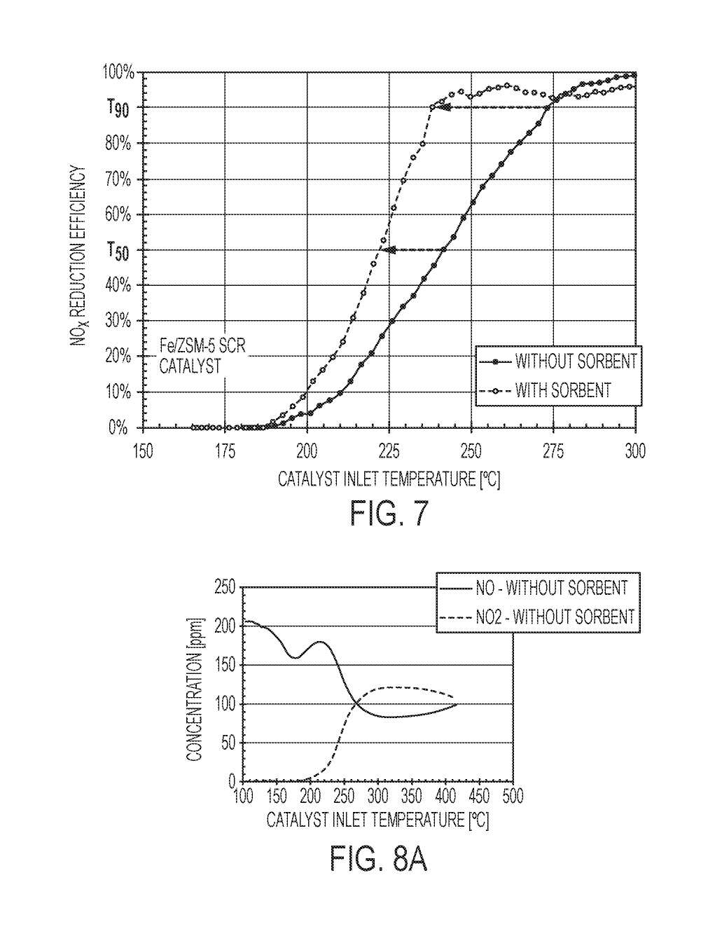

FIG. 7 compares the selective catalytic reduction of NO using a Fe/ZSM-5 SCR without a sorbent and with a sorbent. Using a sorbent according to embodiments described herein results in a decrease in T₅₀ of at least 20° C. and an even greater decrease in T₉₀ of at least 35° C. The catalyst system having the NO SCR catalyst with the sorbent effectively reduces the light-off temperature of the catalyst.

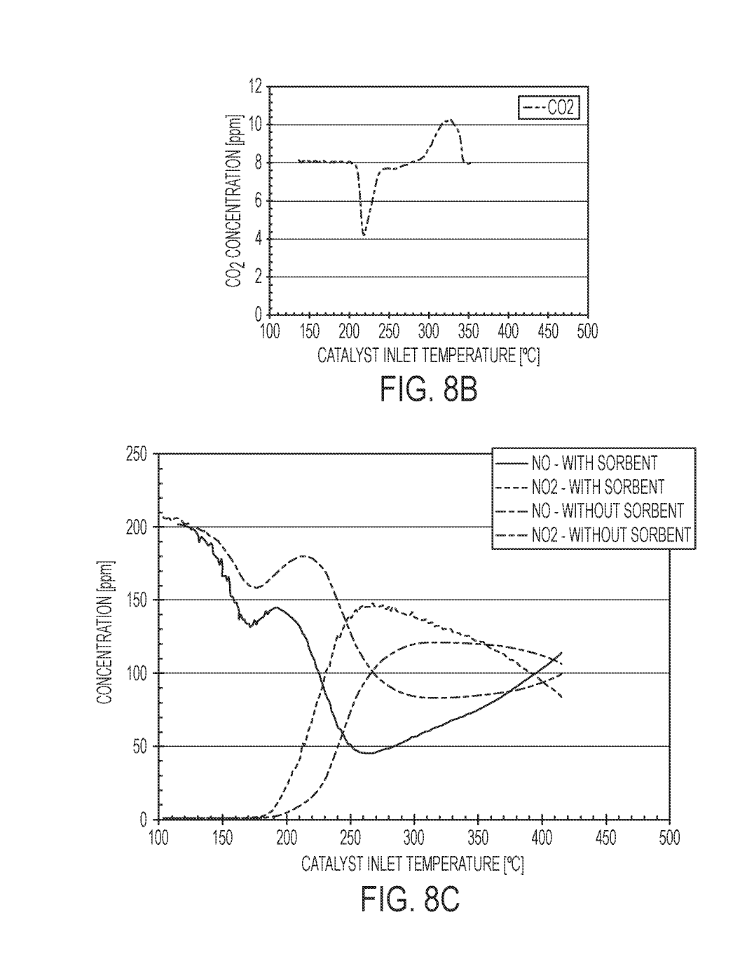

FIGS. 8A-8C demonstrate the impact of the catalyst systems described herein that have a catalyst and a CO₂ sorbent. In particular, the data shown is from oxidation of NO to NO₂ with and without a CO₂ sorbent. FIG. 8A shows the concentrations of NO and NO₂ as a function of the catalyst inlet temperature. FIG. 8B shows the CO₂ concentration as a function of the catalyst inlet temperature. FIG. 8C compares the NO and NO₂ concentrations in a traditional oxidation catalyst and in a catalyst system having the oxidation catalyst and the CO₂ sorbent according to embodiments described herein. Employing an embodiment of the catalyst system results in a 35° C. and 25 ppm improvement because of the decrease in the effective light-off temperature.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

What is claimed is:

1. A method comprising:
exposing engine exhaust to an aftertreatment catalyst system comprising a catalyst support structure having a surface region comprising a criteria-pollutant-treating catalyst and a sorbent comprising a eutectic promotor, wherein the sorbent is based on MgO, on a MgO—Na₂CO₃ double salt, or on dolomite;
exothermically adsorbing CO₂ from the exhaust to the sorbent at a first temperature less than a light-off temperature of the criteria-pollutant-treating catalyst, thereby increasing temperature at the criteria-pollutant-treating catalyst to a value greater than or equal to the light-off temperature; and
desorbing the CO₂ from the sorbent at a second temperature greater than the light-off temperature of the criteria-pollutant-treating catalyst.

2. The method of claim 1, wherein the first temperature is less than 150° C.

3. The method of claim 1, wherein the second temperature is greater than 250° C.

4. The method of claim 1, wherein the sorbent is at a first layer on a surface of the support structure and the catalyst is at a second layer on the first layer, and wherein said adsorbing comprises adsorbing CO₂ to the first layer and said increasing temperature comprises transferring heat from the first layer to the second layer.

5. The method of claim 1, wherein the eutectic promotor has a melting temperature that is less than or equal to 150° C., and wherein the method further comprises melting the eutectic promotor, thereby facilitating said adsorbing CO₂.

6. The method of claim 1, wherein the eutectic promotor comprises a mixture of at least two salts selected from the group consisting of NaNO₃, LiNO₃, KNO₃, Ca(NO₃)₂ Mg(NO₃)₂, NaNO₂, LiNO₂, KNO₂, and CaNO₂.

7. The method of claim 1, wherein the eutectic promotor comprises a ternary mixture of NaNO₃, KNO₃, and NaNO₂, a ternary mixture of LiNO₃, NaNO₃, and KNO₃, or a quarternary mixture of LiNO₃, NaNO₃, KNO₃, and NaNO₂.

8. The method of claim 1, wherein the eutectic promotor is 5 wt % to 60 wt % of the sorbent's total weight.

9. The method of claim 1, wherein the sorbent and the criteria-pollutant-treating catalyst are present in a weight ratio between 1:2 and 4:1.

10. An aftertreatment catalyst for engine exhaust comprising:
A catalyst support structure having a surface region comprising a criteria-pollutant-treating catalyst and a MgO-based, a MgO—Na₂CO₃ double salt-based or a dolomite-based sorbent comprising a eutectic promotor and having a CO₂-capture temperature less than or equal to 150° C. and a CO₂-release temperature greater than or equal to 250° C., wherein the sorbent is a CO₂ exotherm.

11. The aftertreatment catalyst of claim 10, wherein at least a portion of the sorbent is located inside the porosity of the support structure.

12. The aftertreatment catalyst of claim 10, wherein the sorbent is arranged as a first layer and the catalyst is arranged as a second layer, the first layer existing between the support structure and the second layer.

13. The aftertreatment catalyst of claim 10, wherein the sorbent and the catalyst are integrated in a layer on the support structure.

14. The aftertreatment catalyst of claim 10, wherein the eutectic promotor comprises a mixture of salts selected from the group consisting of NaNO₃, LiNO₃, KNO₃, Ca(NO₃)₂, Mg(NO₃)₂, NaNO₂, LiNO₂, KNO₂, and Ca(NO₂)₂.

15. The aftertreatment catalyst of claim 10, wherein the eutectic promotor comprises a ternary mixture of NaNO₃, KNO₃, and NaNO₂, a ternary mixture of LiNO₃, NaNO₃, and KNO₃, or a quarternary mixture of LiNO₃, NaNO₃, KNO₃, and NaNO₂.

16. The aftertreatment catalyst of claim 10, wherein the eutectic promotor is 5 wt % to 60 wt % of the sorbent's total weight.

17. The aftertreatment catalyst of claim 10, wherein the sorbent and the criteria-pollutant-treating catalyst are present in a weight ratio between 1:2 and 4:1.

18. The aftertreatment catalyst of claim 10, wherein the eutectic promotor has a melting temperature that is less than or equal to 150° C.

19. A method comprising applying to a surface of a catalyst support structure a criteria-pollutant-treating catalyst and a MgO-based, a MgO—Na₂CO₃ double salt-based, or a dolomite-based sorbent comprising a eutectic promotor and having a CO₂-capture temperature less than or equal to 150° C. and a CO₂-release temperature greater than or equal to 250° C., wherein the sorbent is a CO₂ exotherm.

20. The method of claim 19, wherein said applying comprises first applying the sorbent or the catalyst as a first layer on the catalyst support structure and subsequently applying the catalyst or the sorbent, respectively, as a second layer on the first layer.

21. The method of claim 19, wherein said applying comprises applying an integrated layer comprising the sorbent and the catalyst.
